(19) United States
(12) Patent Application Publication
(10) Pub. No.: US 2008/0140371 A1
(43) Pub. Date: Jun. 12, 2008

(54) System and method for treating a patient

(75) Inventor: Adrian Francis Warner, Delafield, WI (US)

Correspondence Address: GE HEALTHCARE;c/o FLETCHER YODER, PC, P.O. BOX 692289, HOUSTON, TX, 77269-2289, US

(73) Assignee: General Electric Company

(21) Appl. No.: 11/600,244

(22) Filed: Nov. 15, 2006

(51) Int. Cl. G06G 7/58

(52) U.S. Cl. 703/11

(57) ABSTRACT

A patient treatment method is provided. In one embodiment, the method includes inputting physiological data of a patient into a computer model that is configured to simulate a physiological activity of the patient. The method may also include operating the computer model for each of a plurality of potential treatment options to generate a plurality of personalized modeled results based at least in part on simulated effects of each potential treatment option on the physiological activity. Additionally, the method may include selecting an optimal treatment option from the plurality of potential treatment options based at least in part on the plurality of personalized modeled results, developing a personalized treatment plan comprising the optimal treatment option, and treating the patient based at least in part on the personalized treatment plan. Other methods, systems, and computer-readable media are also disclosed.

### BACKGROUND

The invention relates generally to medical treatment of a patient. More specifically, the present invention relates to a technique for developing a treatment plan for a patient disease state.

The healthcare industry plays an increasingly vital role in the modern world, significantly impacting both the life expectancy and the quality of life of billions of people. In some simpler instances, such as in the case of a sprained ankle or a small laceration, a person may be able to diagnose and treat themselves. In other instances, however, it may be necessary to consult with a medical professional, such as a physician, in order to diagnose and treat more complex disease states, such as heart conditions or various other conditions.

In addressing a disease state and the healthcare needs of a patient, a physician will typically first diagnose the disease state of the patient. Such diagnosis may be performed by the physician alone, or may benefit from the employment of various tools or equipment, such as imaging devices, patient monitors, and the like. The physician may then determine a course of treatment, or therapy, for the disease state. While a number of improvements have been made that may aid a physician in the timely and accurate diagnosis of various disease states, it is believed that significantly less development has occurred in the area of therapy determination.

Particularly, the selection of a particular treatment is typically governed by the abilities, training, and experience of a physician, and his or her ability to consider all of the available patient data and the various potential treatment options available, as well as how such data and various patient attributes (such as genetic factors, cardiac condition, liver condition, previous or present treatments for other medical conditions, and the like) may interact with or affect such treatment options. Thus, while a particular treatment may be effective for one patient, that same treatment may be ineffective, or even cause undesirable effects, in a second patient with the same disease state but having different attributes. Consequently, the quality of care and treatment outcomes in such cases are highly dependent on the physician's ability and available time to analyze the patient data and treatment options to accurately predict the likely outcome of a planned course of treatment.

It would be desirable, therefore, to enhance the accuracy and efficiency of such a therapy determination process.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention generally relate to a patient treatment technique that incorporates computer modeling to simulate the effects of one or more treatments on a patient. In some embodiments, the technique employs actual patient data in combination with one or more mathematical models to determine the likely effect of potential treatment alternatives on a patient. In one embodiment, the mathematical model may be a physiological model, such as a cardiac model. The use of other models in addition to or instead of a cardiac model, however, is also envisaged. Additionally, in some embodiments, the one or more mathematical models may be modified based on patient physiological data to generate a personalized model tuned to the characteristics and/or condition of a particular patient. The model may then be operated to simulate various treatment alternatives and outcomes matched to the patient's physiology to facilitate selection of an optimal treatment plan for the patient.

Various refinements of the features noted above may exist in relation to various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### DRAWINGS

These and other features, aspects, and advantages of the present invention will become better understood when the following detailed description is read with reference to the accompanying drawings in which like characters represent like parts throughout the drawings, wherein:

FIG. 1 is an exemplary processor-based system for implementing various aspects of the present technique in accordance with one embodiment of the present invention;

FIG. 2 is a block diagram generally illustrating various aspects of an exemplary patient treatment system in accordance with one embodiment of the present invention;

FIG. 3 is a flowchart depicting exemplary steps for treating a patient in accordance with one embodiment of the present invention; and

FIG. 4 is a flowchart depicting exemplary operational steps of a computer model that facilitates treatment of a patient in accordance with one embodiment of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Various embodiments of the present technique generally provide an automated or semi-automated technique for determining a preferred or optimal treatment option for a particular patient based on patient data and mathematical modeling. In one embodiment, the present technique is implemented on a computer platform and provides for the modeling of one or more patient disease states, wherein such modeling is personalized based on individual patient data, which may include one or more of physiological data, physical characteristics, genetic data and/or predispositions of the patient, or the like. Further, one or more treatment alternatives may be simulated through use of the personalized model to facilitate analysis of the likely effectiveness and results of the treatment options on particular patient. Based on such a personalized analysis, an optimal treatment option may be selected to develop a treatment plan that has been optimized for the particular patient.

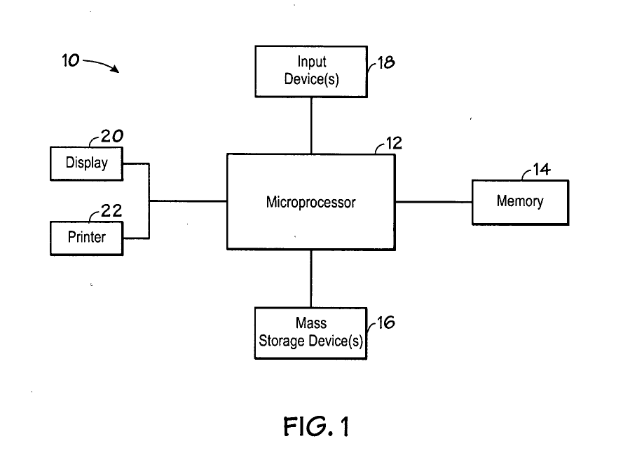

Turning now to the drawings, and referring first to FIG. 1, an exemplary processor-based system 10 for use in conjunction with the present technique is depicted. In one embodiment, the exemplary processor-based system 10 is a general-purpose computer, such as a personal computer, configured to run a variety of software, including software implementing all or part of the present technique. Alternatively, in other embodiments, the processor-based system 10 may comprise, among other things, a mainframe computer, a distributed computing system, or an application-specific computer or workstation configured to implement all or part of the present technique based on specialized software and/or hardware provided as part of the system. Further, the processor-based system 10 may include either a single processor or a plurality of processors to facilitate implementation of the presently disclosed functionality.

In general, the exemplary processor-based system 10 includes a microprocessor 12, such as a central processing unit (CPU), which executes various routines and processing functions of the system 10. For example, the microprocessor 12 may execute various operating system instructions as well as software routines stored in or provided by a memory 14 (such as a random access memory (RAM) of a personal computer) or one or more mass storage devices 16 (such as an internal or external hard drive, CD-ROM, DVD, or other magnetic or optical storage device). In addition, the microprocessor 12 processes data provided as inputs for various routines or software programs, such as data provided as part of the present technique in computer-based implementations.

Such data may be stored in, or provided by, the memory 14 or mass storage device 16. Alternatively, such data may be provided to the microprocessor 12 via one or more input devices 18. As will be appreciated by those of ordinary skill in the art, the input devices 18 may include manual input devices, such as a keyboard, a mouse, or the like. In addition the input devices 18 may include a device such as a network or other electronic communication interface that provides data to the microprocessor 12 from a remote processor-based system or from another electronic device. Such a network communication interface, of course, may be bidirectional, such that the interface also facilitates transmission of data from the microprocessor 12 to a remote processor-based system or other electronic device over a network.

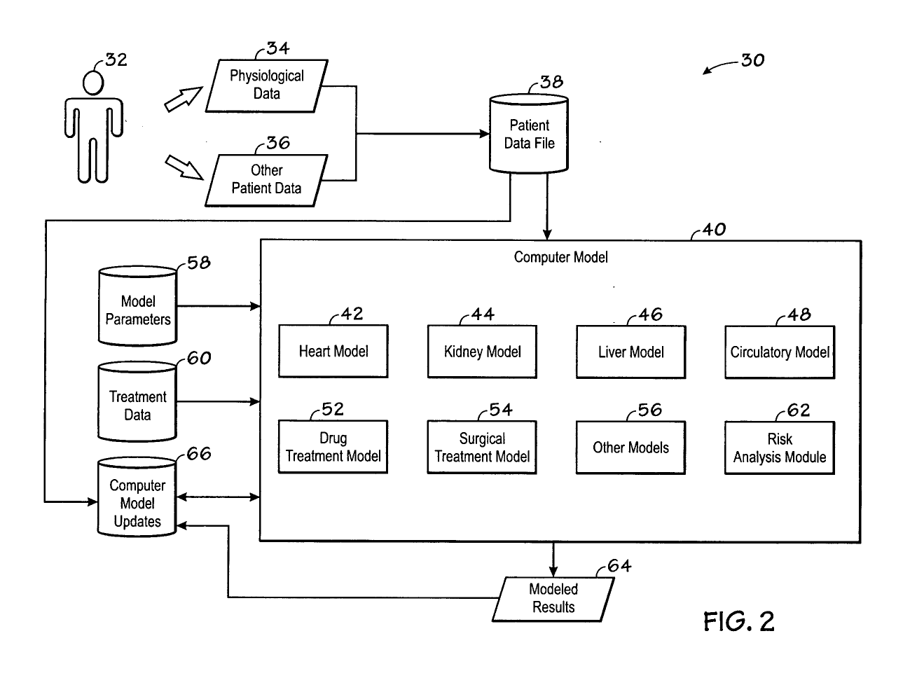

Results generated by the microprocessor 12, such as the results obtained by processing data in accordance with one or more stored routines, are provided to an operator via one or more output devices, such as a display 20 and/or a printer 22. Based on the displayed or printed output, an operator may request additional or alternative processing or provide additional or alternative data, such as via the input device 18. As will be appreciated by those of ordinary skill in the art, communication between the various components of the processor-based system 10 may typically be accomplished via a chipset and one or more busses or interconnects which electrically connect the components of the system 10. Notably, in certain embodiments of the present technique, the exemplary processor-based system 10 is configured to process patient data and run one or more mathematical models to simulate treatment options for a patient, as discussed in greater detail below with respect to FIGS. 2-4.

An exemplary system 30 for facilitating treatment of a patient 32 is illustrated in FIG. 2. In some embodiments, the exemplary system 30 may use actual patient data in combination with one or more mathematical models to simulate the effects of potential treatment options for the patient 32. Accordingly, various physiological data 34 and other data 36 may be collected from the patient 32 and either input directly to one or more mathematical models, such as computer model 40, or the data may be stored in a patient data file of database 38 for future use with such a model.

In various embodiments, the exemplary system 30 may be adapted to utilize a wide array of physiological data 34 and other data 36 depending upon the anatomy of the patient 32 that is to be diagnosed and treated. For instance, to facilitate modeling, diagnosis, and treatment of a cardiac disease state, the physiological data 34 may include one or more of electrocardiogram (ECG) data, computed tomography (CT) data (such as calcification scores), blood flow data (such as from Doppler ultrasound), stress and/or strain data (such as from a magnetic resonance (MR) image), tissue viability data, or the like. The data 34 and 36 may also include additional items of information related to the patient 32, such as physical characteristics (e.g., anatomical data, weight, and so forth), blood chemistry or other biochemical data, and blood pressure, to name but a few. Still further, such data may also include information that may impact the effectiveness of a potential treatment for a particular patient 32, such as genetic data or predispositions (e.g., cardiac membrane sensitivity), liver and/or kidney characteristics (e.g., the ability of a patient's body to break down and/or wash out a drug), medical history, allergies, or other such information.

The data 34 and 36 may be input directly from the patient 32 to the computer model 40, or may instead be input from the database 38. In one embodiment, the computer model 40 includes a variety of components or models that collectively facilitate the simulation of a physiological activity of the patient 32, such as a heartbeat, and simulate the effects of one or more potential treatments on the patient 32. In other words, the computer model 40 enables a physician to simulate the effects of various treatments without actually administering such treatments to the patient 32. Further, as discussed in greater detail below, the inclusion of data 34 and 36 allows the computer model 40 to account for various patient-specific factors that may impact the relative effectiveness and/or advisability of various treatment options, thus providing modeling and results that are personalized for each patient 32.

In various embodiments, the computer model 40 may include an array of component models or sub-models to provide the functionality described above. For instance, the computer model 40 may include one or more physiological models, such as cardiac or heart model 42, kidney model 44, liver model 46, circulatory model 48, and so forth. Additionally, the exemplary computer model 40 may also include various treatment models, such as one or more drug treatment models 52 and/or surgical treatment models 54 corresponding to potential treatment options, which interact with the physiological models to simulate the effect of such treatments on the patient 32. Further, as may be appreciated, the computer model 40 may also include other models 56 in addition to, or in place of, those indicated in the illustrated embodiment to facilitate analysis or treatment of the patient 32.

It should be noted that although the computer model 40 can be used to model treatment options in consideration of a single disease state, in certain embodiments the computer model 40 may consider multiple disease states in modeling treatment options to project the effect of potential treatment options on such disease states. As may be appreciated, the overall effectiveness and/or feasibility of a potential treatment for a disease state may be impacted by a patient's physical characteristics or functioning of other organs or systems, which may be affected by other disease states, such as a second disease state of a different organ or system, or even a second disease state of the same organ or system. In considering the effectiveness of a potential treatment, such as a drug or surgical treatment, the various physiological models may be used to model the likely effect of such treatment on multiple organs or disease states. For example, a potential treatment option for a cardiac disease state may include administration of a pharmaceutical. However, a patient may have physical characteristics or an additional disease state, such as a characteristic or disease state that prevents the patient's kidneys from washing the drug out of the patient, which may reduce the efficacy of the treatment for the cardiac disease state and/or negatively impact the additional disease state. For instance, while a particular drug may be therapeutic for the cardiac disease state, the inability of a patient's kidneys to wash the drug out of the patient's system may lead to a buildup of the drug within the body and the increased toxicity may result in other problems, such as aggravating existing, or creating new, disease states. Accordingly, in one embodiment, the present computer model 40 is configured to model the effect of potential treatment options on multiple organs and/or disease states. Such additional disease states may be modeled by one or more of the physiological models, and may be standardized or personalized based on patient data as discussed above.

Various parameters of the models and treatment data may be stored in one or more databases, such as databases 58 and 60. As discussed below, such treatment data may include risk factors and/or side effects of various treatments that may be taken into account by the model and/or indicated on a report containing the results of various simulations. Additionally, patient care data (e.g., diet considerations, exercise or rest instructions, follow-up care, or the like) may also be input as treatment data 60, as other patient data 36, or in some other manner. The computer model 40 may also include a risk analysis module 62 that may provide a personalized risk analysis of potential treatment options based on both risks inherent in a potential therapy and potential risks arising from patient characteristics or data, drug interactions, previous treatments, physical characteristics, genetic data, patient history, or the like.

The modeled treatment results 64 may be output from the computer model 40 to facilitate selection of an optimal treatment plan by either the system 30 or a physician, and treatment of the patient 32, as discussed in greater detail below. Further, the modeled results 64, as well as outcome and treatment data (e.g. data 34 and 36 collected during or after treatment of the patient 32), may be stored in a database 66 and utilized to update the computer model 40. As will be appreciated, the database 66 may receive such data from a plurality of patients to provide a common body of disease state modeling knowledge to speed updating and refinement of models, such as computer model 40. Further, data from the system 30, such as the data 34 and 36, the modeled treatment results 64, the data from the various databases, and the like, may be output locally or remotely to additional decision support tools.

As may be appreciated, various elements of the system 30 may be provided by a computer system, such as processor-based system 10 of FIG. 1. For instance, the computer model 40 and associated components and models may be realized via a software program stored in memory 14 and/or storage device 16, which has routines that may be executed through use of the microprocessor 12. It will be further appreciated that such functionality may be resident on a single processor-based system, or may be a distributed program spread over multiple devices. Similarly, it will be appreciated that while various databases are distinctly illustrated in FIG. 2, such databases may be consolidated into a single database stored in memory of a system, such as a memory 14 or storage device 16, or spread across multiple devices in a distributed network topology.

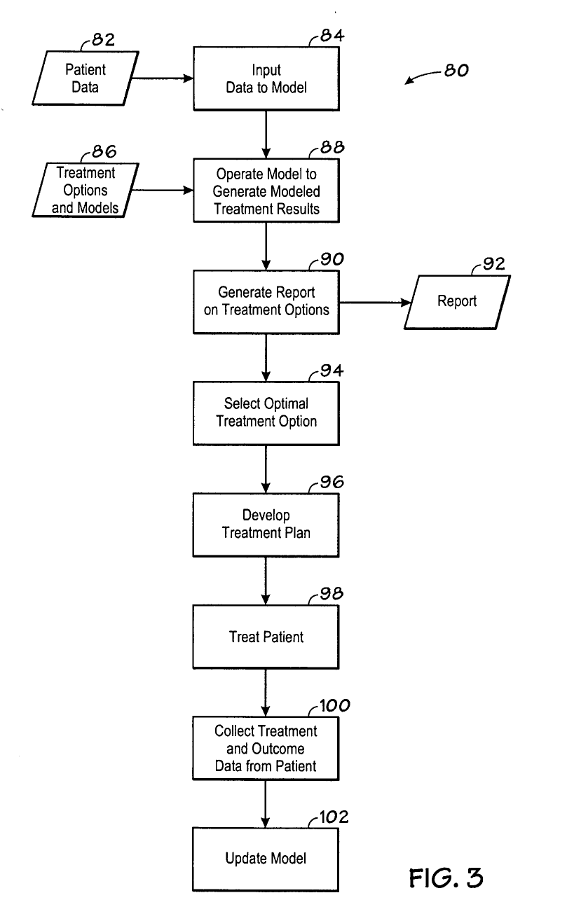

The disease state modeling and patient treatment process may be better understood with reference to flowchart 80 of FIG. 3. It should be noted that one or more of the exemplary steps indicated in flowchart 80 may be performed by the processor-based system 10 through execution of routines of a software application adapted for carrying out such functions. Alternatively, as will be appreciated by one skilled in the art, application specific hardware or circuitry may be employed to provide the same functionality.

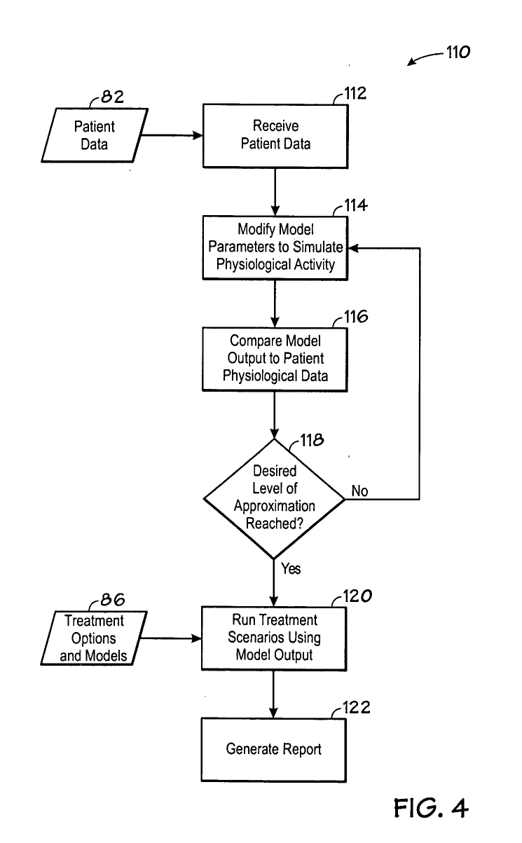

In the embodiment illustrated in FIG. 3, patient data 82 (which may include data 34 and 36 (FIG. 2)) may be input into a mathematical model, such as computer model 40, as indicated in step 84. Various potential treatment options and corresponding models 86 may also be entered into the model, which may then be operated to simulate the effects of potential treatment options on the patient and to generate modeled results of such treatments. As will be appreciated, certain modeled results will be personalized for a given patient based on the interactions between the various treatment models and the patient data 82, as explained in greater detail below with respect to FIG. 4.

Once these modeled results are obtained, a report 92 detailing the modeled results of each treatment option may be generated, as indicated in step 90. As will be appreciated, the report 92 may be output in a number of manners, such as via the display 20 or the printer 22 (FIG. 1), or may be stored for future use by an operator. In one embodiment, the report 92 includes an analysis of the modeled effect of one or more potential treatments on a patient condition. The report 92 may also include a comparative review and analysis of the potential treatment options relative to one another to facilitate selection of an optimal treatment option, as indicated in step 94. In one embodiment, such selection may be performed by a system operator, such as a physician. In other embodiments, however, the selection of an optimal treatment option may be automated, with the optimal treatment option being output to a user.

Additionally, in some embodiments the report 92 includes a chronological analysis of one or more of the potential treatments. In various embodiments, such chronological analysis may indicate the expected progression of such treatments once applied to a patient, the projected outcome or effect of the treatment on the patient, and/or the potential recovery time of the patient. Once a treatment is selected and administered to a patient, the actual progress of the treatment may be compared (chronologically or otherwise) with the previously expected or projected progress of the treatment. Also, data obtained from the patient with respect to the actual progress of an administered treatment may be compared with the projected progress to determine whether the patient is responding to the treatment as expected. If the actual progression of the treatment substantially differs from the expected progression, the course of treatment may be reconsidered and alternative therapies may be administered.

The report 92 may also include various risk factors or treatment side effects, as noted above, which may exist with respect to various treatment options and may be correlated with the patient data 82. Further, the report 92 may also include a risk analysis for the potential treatment options based on the various risk factors associated with the patient data 82 or those associated with the potential treatment options themselves. Still further, in some embodiments, the report may indicate a preferred treatment therapy, rank the treatments (such as by order of preference), and/or highlight those therapies that are not recommended due to adverse reactions in the simulations. Further yet, the report may also include additional predictions as to resulting physiological or physical data, such as cardiac output, vascular resistance, circulatory function, to name but a few.

Through the presently disclosed technique, a physician is able to quickly review the likely effects of potential treatments (via the simulated results) to determine which of these treatments provides the best predicted outcome for a particular patient. In some instances, risk factors specific to a particular patient 32 and highlighted in the report 92 may suggest that a particular treatment may not be viable for a particular patient 32. As noted above, such risk factors may arise from risks of the therapies themselves, or from the patient data, such as genetic data, physical characteristics, drug or other therapy interaction with another treatment or malady, and so forth. For example, the effectiveness of a potential pharmaceutical or drug treatment may depend upon a number of factors, including sensitivity to the drug, and the ability of a patient's body to breakdown and wash out the drug. Further, the potential drug treatment may adversely interact with another medication taken by the patient. For instance, it is possible that these factors may lead to drug-induced prolonged QT syndrome and increased risk of sudden cardiac death (SCD), to provide but one example of many possible interactions. Through the present technique, however, the risk factors may be considered by the physician and/or incorporated into the treatment modeling, resulting in a personalized treatment plan optimized for the best possible outcome.

The exemplary method 80 also includes developing a personalized treatment plan that includes the optimal treatment option and treating the patient 32 accordingly, as indicated in steps 96 and 98, respectively. Additionally, data may be collected from the patient both during and after such treatment as indicated in step 100. Such data may be compared to the modeled or predicted results to determine whether the patient's response to a treatment is within expectations. As noted above, the treatment and outcome data collected from the patient in step 100 and the modeled results may be used to further refine the computer models, such as by improving the accuracy and/or comprehensiveness. As will be appreciated, such data may be remotely collected from a number of patients to facilitate such refinement.

In FIG. 4, an exemplary process flow or flowchart 110 of a model, such as computer model 40, is provided. Initially, the model receives patient data 82, as indicated in step 112. In various embodiments, such patient data 82 includes physiological data related to a physiological activity of the patient 32. In such embodiments, the model may be run to simulate the physiological activity, as indicated in step 114. By way of example, the model may be adapted to simulate a heartbeat of the patient 32. In such a case, actual ECG data from the patient may be input into the model, which then simulates the patient's heartbeat through the production of virtual (modeled) ECG data that approximates the actual ECG data. Particularly, various parameters of the model may be adapted in order to replicate the patient's actual ECG data. However, in another embodiment in which such patient data is not available, such as in the case of a medical emergency, normalized parameters may be used by the model.

The model output, or virtual ECG data in the present example, may be compared to physiological data of the patient (the actual ECG data in the present example), as indicated in step 116. Further, a feedback loop may be implemented via decision step 118 based on discrepancies between the actual data and the virtual data and the desired accuracy level. If further matching is desired, further iterations of the parameter modification and comparison steps 114 and 116 may be performed.

Once the desired level of matching has been achieved, the virtual (modeled) ECG may interact with various treatment models 86 (such as drug and surgical treatment models 52 and 54 of FIG. 2) to run treatment scenarios, as indicated in step 120. More particularly, in one embodiment, a physician may select one or more proposed treatment options for the patient's condition. Treatment models corresponding to the proposed treatment options may then interact with the virtual data model (the cardiac simulation in the present example) to generate modeled or predicted results of each proposed treatment option. The treatment models corresponding to the proposed treatment options may be stored locally, or may be received or imported from a remote library or database. Further, in one embodiment, additional treatment models may be added, and existing models may be further refined and updated, such as through a subscription based service, which would allow model development to be monetized by various model suppliers. In the present cardiac example, the patient's personalized cardiac model created via steps 114, 116, and 118 may then be used to run various treatment scenarios corresponding to the proposed treatment options. A report may be generated, as indicated in step 122, which details the expected effects of each treatment option on the patient and may include various risk factors, allowing a physician to select an optimal course of treatment for the patient 32 without physically subjecting the patient to the various alternative treatment options.

While the present technique has been described above with respect to a general cardiac example, it will be appreciated that the present technique may be beneficially applied to other cardiac applications, as well as to other anatomies. For instance, the present technique may aid in determining treatments for a patient suffering a heart attack, allowing for analysis of a wide array of potential therapies, including thrombolytic therapy, angioplasty, other surgery, drug treatments, and other available treatments. Use of the present techniques in other cardiac and non-cardiac applications is also envisaged.

Consequently, through the presently disclosed technique, a healthcare provider is able to optimize a treatment plan for a given patient based on the most viable treatment options available. Further, the treatment plan may be personalized based on data collected from that patient, and ineffective or undesirable treatment methods may be avoided. Still further, the presently disclosed technique may serve as a computerized second opinion and may reduce the amount of time necessary to accurately diagnose and treat a patient.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A patient treatment method comprising:
inputting physiological data of a patient into a computer model configured to simulate a physiological activity of the patient;
operating the computer model for each of a plurality of potential treatment options to generate a plurality of personalized modeled results based at least in part on simulated effects of each potential treatment option on the physiological activity;
selecting an optimal treatment option from the plurality of potential treatment options based at least in part on the plurality of personalized modeled results;
developing a personalized treatment plan comprising the optimal treatment option; and
treating the patient based at least in part on the personalized treatment plan.

2. The method of claim 1, wherein the physiological data comprises actual electrocardiogram (ECG) data and the computer model comprises a cardiac model configured to simulate a heartbeat of the patient via production of virtual ECG data that approximates the actual ECG data.

3. The method of claim 2, wherein operating the computer model comprises generating the virtual ECG data.

4. The method of claim 2, wherein the computer model comprises at least one of a kidney model, a liver model, or a circulatory model.

5. The method of claim 1, wherein the computer model comprises a plurality of treatment models corresponding to the plurality of potential treatment options.

6. The method of claim 5, comprising importing the plurality of treatment models from a remote database.

7. The method of claim 1, comprising generating a report including an analysis of a predicted effect of one or more potential treatment options of the plurality of potential treatment options on the patient.

8. The method of claim 7, wherein the report includes a risk analysis of the one or more potential treatment options.

9. The method of claim 8, wherein the risk analysis is at least partially based on patient-specific risk factors.

10. The method of claim 9, wherein the patient-specific risk factors include at least one of a potential drug interaction, interaction with a previous therapy, physiological characteristics, or a genetic predisposition.

11. The method of claim 7, wherein the analysis of the predicted effect is a chronological analysis.

12. The method of claim 7, wherein the report includes a comparison of an actual effect on the patient of at least one potential treatment option of the one or more potential treatment options that is administered to the patient and the predicted effect of the at least one potential treatment option.

13. The method of claim 7, wherein the analysis of the predicted effect includes a projected recovery time for the patient.

14. The method of claim 1, wherein the computer model comprises at least one of a kidney model, a liver model, or a circulatory model.

15. The method of claim 1, comprising collecting the physiological data of the patient.

16. The method of claim 1, comprising updating the computer model based on treatment data and/or outcome data collected from a plurality of patients.

17. The method of claim 1, wherein the optimal treatment option comprises a surgical procedure and/or a drug therapy.

18. A patient treatment system comprising:
a memory device having a plurality of routines stored therein; and
one or more processors configured to execute the plurality of routines stored in the memory device, the plurality of routines comprising:
a routine for receiving physiological data of a patient;
a routine for simulating a physiological activity of the patient;
a routine for generating a plurality of personalized modeled results from a plurality of potential treatment options via a computer model, wherein the plurality of personalized modeled results is based at least in part on simulated effects of each potential treatment option on the physiological activity; and
a routine for generating a report including an analysis of a predicted effect of at least one potential treatment option of the plurality of potential treatment options on the patient.

19. The system of claim 18, wherein the plurality of routines comprises a routine for selecting an optimal treatment option from the plurality of potential treatment options.

20. The system of claim 18, wherein the plurality of routines comprises a routine for updating the computer model based at least in part on treatment data and/or outcome data collected from a plurality of patients.

21. One or more computer-readable media having application instructions for facilitating treatment of a patient encoded thereon, the application instructions comprising:
instructions adapted to receive physiological data of a patient;
instructions adapted to simulate a physiological activity of the patient;
instructions adapted to generate a plurality of personalized modeled results from a plurality of potential treatment options via a computer model, wherein the plurality of personalized modeled results is based at least in part on simulated effects of each potential treatment option on the physiological activity; and
instructions adapted to generate a report including an analysis of a predicted effect of at least one potential treatment option of the plurality of potential treatment options on the patient.

22. The one or more computer readable media of claim 21, wherein the application instructions comprise instructions adapted to select an optimal treatment option from the plurality of potential treatment options.

23. The one or more computer readable media of claim 21, wherein the application instructions comprise instructions adapted to update the computer model based on treatment data and/or outcome data collected from a plurality of patients.

24. The one or more computer readable media of claim 21, wherein the application instructions comprise instructions adapted to receive additional patient data including at least one of a patient drug regimen, allergies, physiological characteristics, or genetic data.
